(19) United States
(12) Patent Application Publication
(10) Pub. No.: US 2025/0348532 A1
(43) Pub. Date: Nov. 13, 2025

(54) GRAPH DATA STRUCTURE SEARCH TECHNIQUES

(71) Applicant: Apple Inc., Cupertino, CA (US)

(72) Inventors: Aditya Pal, Cupertino, CA (US); Jennifer A. Clark, Cupertino, CA (US); Lee A. Morgan, Cupertino, CA (US); Patrick H. Kelly, San Francisco, CA (US); Bowei Jia, Cupertino, CA (US); Joseph E. Maag, San Francisco, CA (US)

(73) Assignee: Apple Inc., Cupertino, CA (US)

(21) Appl. No.: 19/205,196

(22) Filed: May 12, 2025

Related U.S. Application Data
(60) Provisional application No. 63/646,710, filed on May 13, 2024.

(51) Int. Cl. G06F 16/538; G06F 16/51

(52) U.S. Cl. CPC G06F 16/538; G06F 16/51

(57) ABSTRACT

The techniques may include accessing a corpus of data files (e.g., image files). The techniques may include analyzing the metadata of the data files to identify signals. The techniques may include generating a knowledge graph data structure representing associations data files and the signals. Also, the techniques may include traversing the graph to generate a respective score for each of the plurality of signals. Further, the techniques may include generating a search object for each signal. In addition, the techniques may include ranking the search objects; the ranking based at least in part on the score for each signal of the plurality of signals. The techniques may include generating a phrase from the plurality of signals and the plurality of ranked search objects. Moreover, the techniques may include presenting the phrase on a graphical user interface.

### CROSS-REFERENCES TO OTHER APPLICATIONS

This application claims priority to U.S. Provisional Application No. 63/646,710, for “GRAPH DATA STRUCTURE SEARCH TECHNIQUES” filed on May 13, 2024, which is herein incorporated by reference in its entirety for all purposes.

### FIELD

The disclosure relates to techniques for searching unstructured data. Specifically, the disclosure relates to performing searches of a corpus of files.

### BACKGROUND

Mobile device users may generate a corpus of files that includes a large volume of various types of files, including image files or other types of files. These files may include metadata identifying information about when and where the file was created, but there may be little information identifying the content of each file. Accordingly, locating a specific image file within the corpus may require an understanding of when and where that specific file was captured. Thus, improvements to searching a corpus of files are desirable.

### BRIEF SUMMARY

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

In one general aspect, techniques may include accessing a corpus of data files, where each data file of the corpus of data files may include respective metadata. The data files can include any combination of image files, audio files, video files, word processing files, and spreadsheet files. Techniques may also include identifying a plurality of signals based at least in part on an analysis of the respective metadata of each data file of the corpus of data files. The techniques may furthermore include generating a knowledge graph data structure representing associations between the corpus of data files and the plurality of signals. The techniques may moreover include traversing the knowledge graph data structure to generate a respective score for each signal of the plurality of signals. The techniques may also include generating a plurality of search objects having a respective search object for each signal of the plurality of signals. The techniques may furthermore include ranking the plurality of respective search objects for each signal of the plurality of signals to generate a plurality of ranked search objects, the ranking based at least in part on the score for each signal of the plurality of signals. The techniques may in addition include generating a phrase from the plurality of signals and the plurality of ranked search objects. The techniques may moreover include presenting the phrase as a graphical element of a graphical user interface of the photo application on a display of the mobile device according to the ranking. Other embodiments of these techniques include corresponding methods, computer systems, apparatus, and computer programs recorded on one or more computer storage devices, each configured to perform the actions of the techniques.

Implementations may include one or more of the following features. Techniques where the signals may include one or more of a plurality of signal categories having: persons; pets; cities; states; scenes; meanings; seasons; public events; holidays; trips; business names; home locations; and work locations. Techniques where multiple signals can correspond to a particular category of the plurality of signal categories. The techniques may include: receiving an input identifying the graphical element, where the graphical element is displayed on a first region of the graphical user interface; searching the corpus of data files to identify one or more matching data files; and presenting the one or more matching data files on a second region of the graphical user interface. Techniques where the metadata of a data file captured by the mobile device at a capture location may include information identifying at least: a label for each identified entity, where an entity is a person or an animal; an altitude at the capture location; a latitude of the capture location; a longitude of the capture location; a name of the capture location; a timestamp; a speed of the mobile device; a direction of travel of the mobile device; and an orientation of the data file. Techniques where analyzing the metadata may include: comparing pairs of metadata files to identify information that is present in a first metadata of the pair of metadata files and absent from a second metadata file of the pair of metadata; and associating the identified information with the second metadata. Techniques may include: identifying two or more data files with corresponding metadata that contain information identifying a common capture location and a common timestamp; and associating the two or more data files with an event at the common capture location and the common timestamp. Techniques where the metadata of two data files contain information identifying the common capture location if: a first capture location of a first data files of the two data files is within a threshold distance of a second capture location of a second data file of the two data files. Techniques where analyzing metadata of the corpus of data files may include: filtering the corpus of data files to identify a set of recent data files; and identifying, by the photo application of mobile device, the plurality of concepts in metadata files of the set of recent data files. Techniques where generating the phrase may include: identifying a template that corresponds to a particular search object; identifying a system language of the mobile device; providing, by the photo application of mobile device, the template and the particular search object to a machine learning model that is trained to generate language in the system language; and receiving the phrase as output from the machine learning model. Implementations of the described techniques may include hardware, a method or process, or a computer tangible medium.

### BRIEF DESCRIPTION OF THE DRAWINGS

FIG. 1 is a simplified flow chart illustrating a method for performing a search of a corpus of image files according to various embodiments.

FIG. 2 is an architecture of an application for performing a search of a corpus of data files according to various embodiments.

FIG. 3 is a sequence diagram showing a technique for performing a search of a corpus of data files according to various embodiments.

FIG. 4 is a flowchart illustrating a method for performing a search of a corpus of data files according to various embodiments.

FIG. 5 shows a technique for training a machine learning model according to at least one embodiment.

FIG. 6 shows an example machine learning model of a neural network to at least one embodiment.

FIG. 7 is a block diagram of an example electronic device according to at least one embodiment.

### DETAILED DESCRIPTION

Certain embodiments are directed to techniques (e.g., a device, a method, a memory or non-transitory computer readable medium storing code or instructions executable by one or more processors) for performing a search of a corpus of unstructured image files.

An application of a user device may store a corpus of data files. The data files in the corpus can include any combination of image files, audio files, video files, word processing files, and/or spreadsheet files.

A corpus of images can include data files that were created by a particular device or a particular user account. For example, the corpus of data files can be a corpus of image files that were captured by a user's electronic device. The corpus may include a large number of unstructured data files that are organized by the time and location where each data file was generated. This corpus of files can be sufficiently large that it can be difficult to manually browse, and it may be difficult to identify a particular file without knowing when and where the file was generated.

Text based queries may be used to locate a particular file. However, while the corpus of data files may be sufficiently large to make manual browsing impractical, the corpus may be small enough that not all text queries will return meaningful results. For example, a corpus of image files may contain 30,000 photographs generated by a mobile device user over the last five years. This corpus of image files is sufficiently large that it may be tedious to browse manually, however, the corpus is very small when compared to the search space for an internet search engine. Accordingly, a user may be confronted by a problem of not knowing what search terms will provide meaningful results because the corpus of image files is relatively small when compared to other searchable databases. For example, an internet search engine may return many results for “dolphin in Spain” but the corpus of image files may not include any matching results for that query.

An application managing the corpus of image files can suggest query terms based on the files in the corpus. These suggested search terms can help guide the user towards meaningful search terms based on the content of the corpus of data files. These suggested search terms can help the user to understand the contents of the corpus and understand how to structure queries for the corpus of data files.

The queries can be created from templates that can be used with multiple languages. The application analysis the corpus of data files to identify and rank signals (e.g., terms, labels, categories) within the corpus. These signals are used to create language agnostic search objects that link data files to a particular signal. The application can provide a template, one or more search objects, and information about the application's system language to a machine learning model that is trained to generate phrases. The phrases output by the model can be presented on a graphical user interface as suggested queries. The search objects can be timestamped rotated so that recently used search objects are not repeatedly suggested to the user within a particular timeframe. The search objects, queries, or templates can be timestamped with a time when they were presented to the user and an object, query, or template may not be presented until a threshold amount of time since the timestamp has elapsed. The generated phrases, or template types, may be ranked in some instances with people and scene-based phrases or templates weighted higher in the rankings. The phrases or templates may be stored on local memory for improved search speed.

The search objects can be ranked by the application. To rank these search objects, the application can create a knowledge graph data structure from the corpus of data files. The corpus can include nodes connected by edges representing a relationship between two connected nodes. The nodes can include signal nodes corresponding to a particular signal (e.g., person, pet, city, state, country, scene, meaning, season, public event, holiday, trip, business name, home location, and work location). In addition, the graph data structure can include cluster nodes representing one or more data files that are closely aligned spatially or temporally. For example, a first data file that was generated at a particular location or timeframe may be designated as a cluster node and any files within a threshold distance or threshold timeframe of the first data file may be added to the cluster.

The edges can connect a cluster node and a signal node when the cluster contains at least one data file corresponding to the signal represented by the signal node. For example, a cluster node with image files from Yin's birthday party in San Antonio may be connected to signals for Yin, Birthday, San Antonio, and Texas. A signal's significance can be determined by how many nodes its corresponding signal node is connected to. For example, if the Birthday signal node is connected to a large number of cluster nodes, it can be assumed that the user generating the files views birthdays as important and that a search for a query with “birthday” will return a large number of results.

To rank the signals, the application can traverse the graph data structure to generate a score for each signal. The application uses one or more algorithms to guide a traversal process where each node in the graph is visited. The order in which the nodes are visited, or the number of times they are visited, is used to determine a score for that node. The scores can be weighted and normalized based on the frequency with which the scores appear in the corpus (e.g., via term frequency-inverse document frequency techniques). These scores can be used to generate search objects as discussed above. These search objects, and rankings, are provided to the search infrastructure so that the search object can be used to locate corresponding image files. This ranking procedure is performed periodically and, for instance, may occur every two days.

The search infrastructure can support plain text searches or tokenized searches. As a user texts, the search infrastructure of the application can identify text that partially matches a search object (e.g., a user typing “Cat” may cause the infrastructure to suggest “Catherine”). Selecting a token can limit the search to the data files associated with the search object corresponding to the token, and a plain text search can result in a broad search for all matching fields in the corpus of data files. When a tokenized term is recognized, or when a previous tokenized term is selected, the graphical user interface can present tokens and a count of how many search results may are associated with that token. The presented tokens can include a token matching the typed text and any tokens that, if combined with the existing query, would return a non-zero number of search results. If a plain language search term is suggested, the search infrastructure of the application may prioritize exact matching terms before partially matching terms (e.g., “cat” would be prioritized over “cathedral” for the search described above).

In an illustrative example, a user selects a graphical user interface of an application to look at a corpus of image files. The user may be unsure how to search the corpus, but the graphical user interface can present several suggestions include “Jenny in Barcelona” and “Christmas in France” The suggestions were made because the user's close friend Jenny is present in a large number of photos from a trip to Barcelona, and the user took many photos during Christmas at her French mother's home. The user selects “Jenny in Barcelona” and views the associated photos. The following day, the user opens the application for a second time. Since the users last interaction, the time since the user's Christmas visit to France has exceeded a threshold and the interface does not present “Christmas in France” as a suggestion. Also, “Jenny in Barcelona” was selected on the user's last interaction with the application and the suggestion is removed from the list of potential queries. Accordingly, the user interface presets the next highest ranked suggestions including “Ski Trip to Vail” and “Paul at Work.”

Some or all of the process (or any other processes described herein, or variations, and/or combinations thereof) may be performed under the control of one or more computer systems configured with executable instructions and may be implemented as code (e.g., executable instructions, one or more computer programs, or one or more applications) executing collectively on one or more processors, by hardware or combinations thereof. The code may be stored on a computer-readable storage medium, for example, in the form of a computer program comprising a plurality of instructions executable by one or more processors. The computer-readable storage medium may be non-transitory.

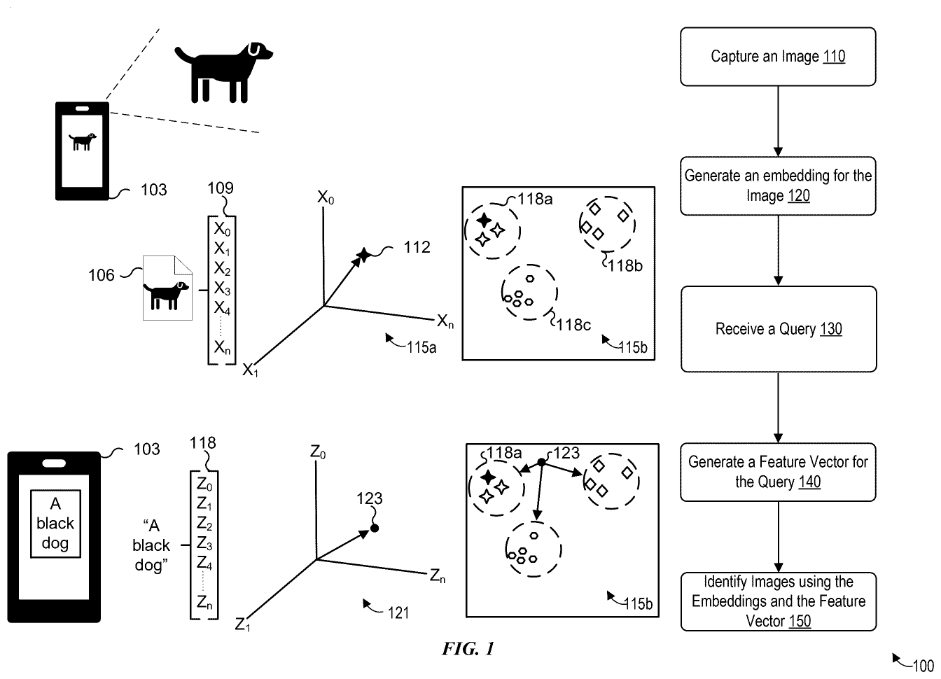

FIG. 1 is a simplified flow chart illustrating a method 100 for performing a search of a corpus of image files according to various embodiments. In some implementations, one or more method blocks of FIG. 1 may be performed by a mobile device (e.g., photo application 200, mobile device 700). In some implementations, one or more method blocks of FIG. 1 may be performed by another device or a group of devices separate from or including the mobile device. Additionally, or alternatively, one or more method blocks of FIG. 1 may be performed by one or more components, such as processor 718, computer-readable medium 702, Input/Output (I/O) subsystem 706, wireless circuitry 708, etc.

Turning now to FIG. 1 in greater detail, at block 110, an image can be captured. The image can be captured by mobile device 103, but any suitable computing device or computing system can be used to capture the image. The image can be an image file 106 that is generated by the mobile device 103. The image file 106 may be part of a large corpus of image files that were generated by the mobile device 103, and embeddings may help the mobile device's user to search for specific images within this corpus.

At block 120, an embedding can be generated for the image file. The embedding 109 can be an ordered list of numeric properties that represent information about the image file 106. The terms embedding and feature vector may be used interchangeably in this disclosure, and both terms refer to an ordered list of numeric properties for an entity, object, phrase, etc.

The embedding 109 may be generated by providing the image file 106 as input to a machine learning model that is trained to extract numeric properties from an image. For example, the features can include the color intensity for each pixel in the image, and this information for each pixel may be represented as a first number that represents the pixel's red color intensity, a second number that represents the pixel's green color intensity, and a third number that represents the pixel's blue color intensity.

The model may combine information for groups of pixels, and the combined information may also be recorded in the embedding. The model may use this pixel information to identify features in the image. For example, a change in color intensity between neighboring pixels may indicate the edge of an object. In addition, the embedding may also include nonvisual information about the image file 106, and for example, the embedding may record metadata information about when and where the image file 106 was generated.

The embeddings can help represent information about an image file 106 in a format that allows a computer to group the file with similar images. The embedding 109 is an n-dimensional numeric representation of information about image file 106, and the embedding can be plotted in an n-dimensional space where each axis in this higher dimensional space represents the range of possible values for each embedded property.

The embedding 109 points to a location 112 in this embedded space 115 (e.g., feature space). The coordinates of the location 112 can correspond to the numeric properties for the image file 106, and there may be tens, hundreds, or thousands of axes in the embedded space 115. FIG. 1 includes simplified embedded space representations with reduced dimensionality, and, for example, embedded space 115a is a three-dimensional representation of the embedded space and embedded space 115b is a two-dimensional representation of the embedded space.

Embeddings for the image files in the corpus of images may be plotted in the embedded space, and this can be used to identify similar image files. Image files that are close in embedded space may be similar, and image files that are plotted in different parts of embedded space may not be similar. Proximity in image space can be used to identify clusters of related image files 118a-118c.

At block 130, a query can be received at the mobile device 103. The image captured at block 110 can be a representation of a black dog, and the query may be a request for “a black dog.”

At block 140, a feature vector can be generated for the query. The feature vector 118 can represents the query's textual characteristics in feature space 121. The feature vector 118 may include one or more numeric values that represent each word in the query, the semantic relationships between words, and the role of each word in the query.

At block 150, images that are relevant to the query can be identified using the embeddings and the feature vectors. A machine learning model may be trained to identify appropriate image embeddings for a given query feature vector. The properties of the feature vectors and the embeddings can be aligned by adjusting the model's weights and parameters until the model returns appropriate embeddings in response to a given feature vector. The trained model can plot the feature vector at location 123 in the two-dimensional embedded space representation 115b. The model can identify cluster 118a as containing images that are related to the query because these images' embedded space representations are close to location 123.

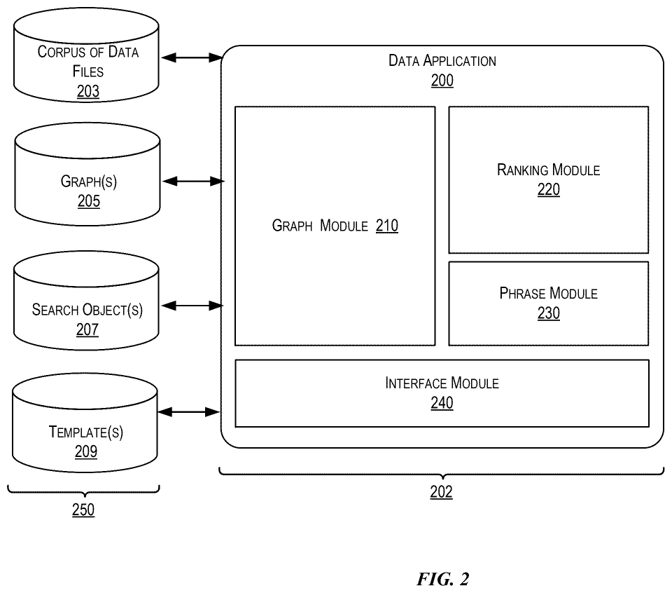

FIG. 2 is a schematic diagram of an example computer architecture for a data application 200 (e.g., a photo application), including a plurality of modules that may perform functions in accordance with at least one embodiment. The modules may be software modules, hardware modules, or a combination thereof. If the modules are software modules, the modules can be embodied on a computer readable medium and processed by a processor in any of the computer systems described herein. It should be noted that any module or data store described herein, may be, in some embodiments, be a service responsible for providing functionality corresponding to the module described below. The modules 202 may be execute as part of the data application 200, or the modules 202 may exist as separate modules or services external to the data application 200. In some embodiments, the modules 202 may be executed by the same or different computing devices, as a service, as an application, or the like.

In the embodiment shown in the FIG. 2, data store 250 such as corpus of data files 203, graph(s) 205, search object(s) 207, and template(s) 209 are shown, although data can be maintained, derived, or otherwise accessed from various data stores, either remote or local to the data application 200, to achieve the functions described herein. The data files can be any type of data files in various embodiments. For example, the data files can be any combination of audio files, image files, video files, word processing files, and spreadsheet files. The data application 200, as shown in FIG. 2, includes various modules such as a graph module 210, a ranking module 220, a phrase module 230 and an interface module 240. Some functions of the modules 210-150 are described below. However, for the benefit of the reader, a brief, non-limiting description of each of the modules is provided in the following paragraphs. In accordance with at least one embodiment, a process for performing a search of a corpus of image files is provided.

In at least one embodiment, the data application 200 (e.g., the application) includes the graph module 210. Generally, the graph module 210 may generate a knowledge graph data structure (e.g., graph(s) 205) from data files (e.g., corpus of data files 203). The graph module 210 may use temporal and location information in the metadata of the data files to cluster data files that were generated (e.g., captured) at a similar location or a similar point in time. The graph module 210 may create a node (e.g., cluster nodes) in the graph data structure for these clustered data files. In some embodiments, the graph module 210 may generate these nodes for individual data files if the temporal data is not within a threshold time period of the temporal data of another data file and the location data is not within a threshold distance of another the location data of another data file.

The graph module 210 may identify signals in the metadata of the data files. Signals can include one or more signals in any combination of the following categories: persons, pets, cities, states, scenes, meanings, seasons, public events, holidays, trips, business names, home locations, and work locations. A scene for an image file can be a particular image composition, and, for example, scenes could include landscape photos, portraits, still life images, pastoral scenes, beach scenes, mountain scenes, athletic events, and animal photos. The graph module 210 can identify the signals through an analysis of the metadata for image files. For example, location information in the metadata (e.g., altitude, latitude, longitude, a name of the location) and temporal information (e.g., a timestamp) can be cross referenced against event data to identify public events corresponding to when the data file was generated. The temporal data and location data can similarly be used to identify holidays, business names, home locations, work locations, cities, states, countries, and the like.

In at least one embodiment, the data application 200 (e.g., the application) includes the ranking module 220. Generally, the ranking module 220 may generate a score for signals. The scores can be generated by traversing the nodes in the graph data structure. The ranking module 220 can employ a traversal algorithm that causes the ranking module 220 to visit every node in the graph data structure. The algorithm begins at one node and moves through the graph data structure (e.g., graph(s) 105) until each node has been visited. During this traversal, the number of times each node is visited is recorded. This process can be repeated with different beginning nodes, and, at the end of the traversals, the number of times that a node was visited can be a score for that node. In addition or alternatively, the increment to the score for a particular visit to a particular node can be weighted by information about the preceding node. For example, a first increment for a visit to a signal node that was visited from a large cluster node (e.g. a cluster node corresponding to multiple data files) may be larger than a second increment for a visit to the signal node where the preceding node was a cluster node with a single data file. The score may be normalized in some embodiments.

The ranking module 220 may be used to generate a search object 207 for each signal. The scores for the nodes corresponding to a signal can be used to rank the data object representing that signal. The search object 207 can be written to the search infrastructure to identify data files that correspond to the search object. Accordingly, the search object 207 may be used to retrieve data files corresponding to the search object. The rankings and search objects may be generated periodically, and, for instance, they can be generated every 4 hours, every 6 hours every 8 hours, every 12 hours, once a day, once every two days, once every three days, once every four days, once a week once every two weeks, and once a month.

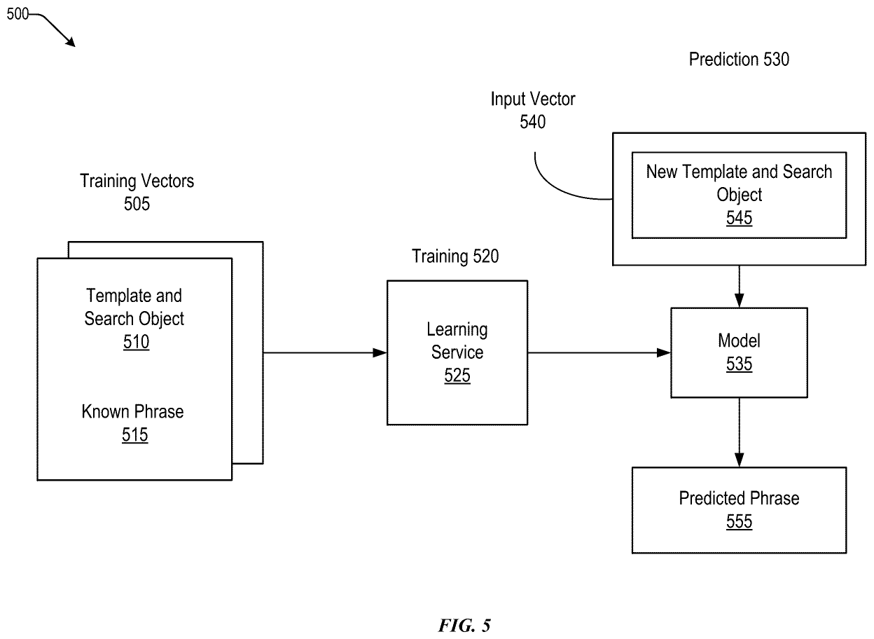

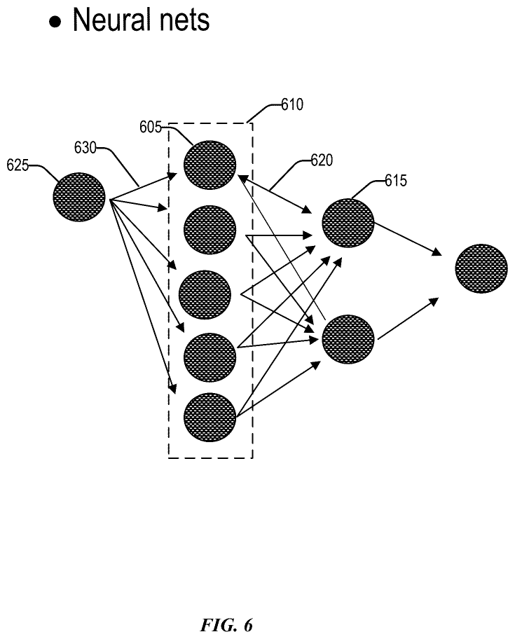

In at least one embodiment, the data application 200 (e.g., the application) includes the phrase module 230. Generally, the phrase module 230 can generate a phrase from the plurality of signals identified in the graph 205 and the search objects 207. The phrase module 230 can detect a system language for the data application 200 or the device upon which the data application 200 executes. The phrase module 230 can use the language, the templates 209, and the data objects as input to a machine learning model in the phrase module 230 that is trained to generate a phrase as described with reference to FIGS. 5 and 6. A template 209 can be an ordered relationship between search objects (e.g., “<person search object 1> in <location search object 2>”). In some embodiments, a set of data objects may be selected based on the rankings of their corresponding signals, and phrases may be generated for these selected data objects. In some embodiments, a data object may be removed from the selected data object if the data object was used to generate a phrase within a threshold amount of time.

In at least one embodiment, the data application 200 (e.g., the application) includes the interface module 240. Generally, the interface module 240 can be used to generate and present a graphical user interface. A graphical element can be generated for each phrase and presented in a first portion of the graphical user interface. The interface module 240 can receive an input identifying a graphical element and the interface module can use the data objects corresponding to the graphical element to retrieve the corresponding data files. The retrieved data files can then be presented in a second portion of the graphical user interface.

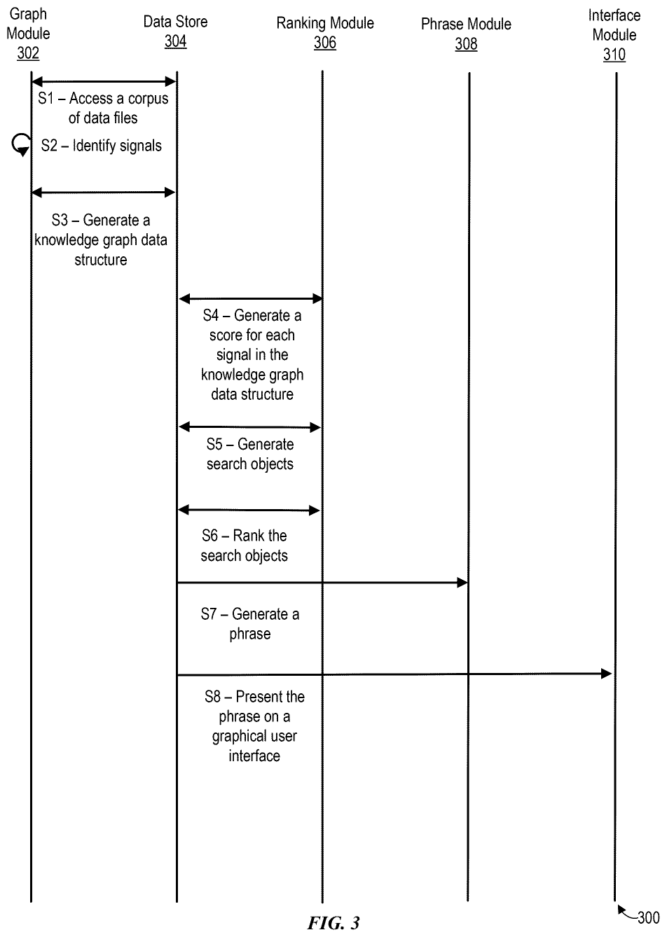

FIG. 3 is a sequence diagram 300 showing a technique for performing a search of a corpus of image files according to various embodiments. The image files can be any type of data files in various embodiments. For example, the data files can be any combination of audio files, image files, video files, word processing files, and spreadsheet files. At S1, the graph module 302 can access a corpus of data files from a datastore 304.

At S2, the graph module 302 can identify signals in the corpus of data files accessed from the data store 304 at S1.

At S3, the graph module 302 can generate a knowledge graph data structure using the data files accessed at S1 and the signals identified at S2. The knowledge graph data structure can be stored to the data store 304.

At S4, the ranking module 306 can generate a score for each signal in the knowledge graph data structure that was generated at S3.

At S5, the ranking module 306 can generate the search objects for each signal identified at S2.

At S6, the ranking module 306 can rank the search objects generated at S5 and the scores from S4.

At S7, the phrase module 308 can generate a phrase using the signals identified at S2 and the ranked search objects from S6.

At S8, the interface module 310 can present a graphical user interface that displays the phrases that were generated at S7.

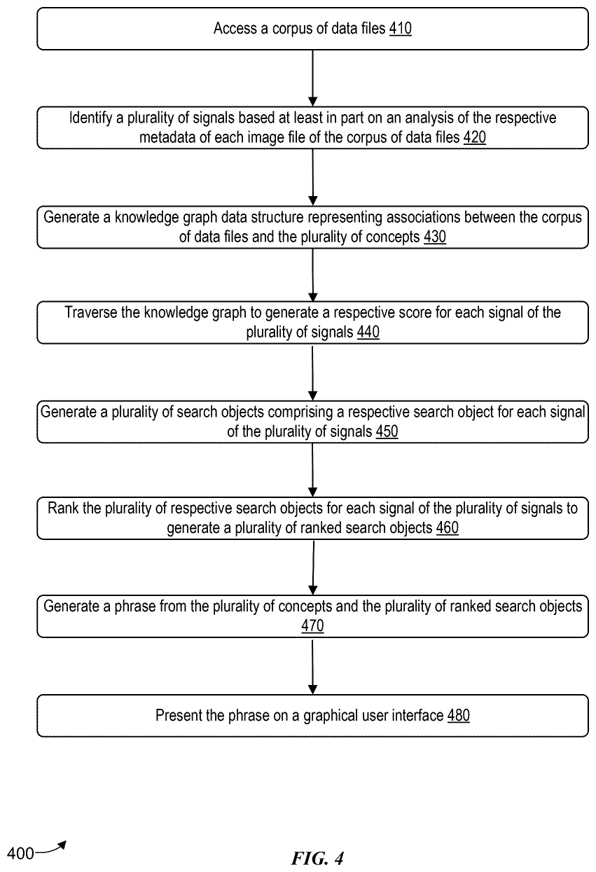

FIG. 4 is a flowchart illustrating a method 400 for performing a search of a corpus of image files according to various embodiments. The image files can be any type of data files in various embodiments. For example, the data files can be any combination of audio files, image files, video files, word processing files, and spreadsheet files. In some implementations, one or more method blocks of FIG. 4 may be performed by a mobile device (e.g., user equipment 22, data application 100, electronic device 700). In some implementations, one or more method blocks of FIG. 4 may be performed by another device or a group of devices separate from or including the mobile device. Additionally, or alternatively, one or more method blocks of FIG. 4 may be performed by one or more components, such as processor 718, computer-readable medium 702, Input/Output (I/O) subsystem 706, wireless circuitry 708, etc.

At block 410, a corpus of data files can be accessed. The data files can be any combination of image files, audio files, video files, word processor files, and spreadsheet files. Each data file of the corpus of data files includes respective metadata for that data file. The corpus of data files can be accessed by a data application (e.g., a photo application).

At block 420, a plurality of signals can be identified based at least in part on the analysis of the respective metadata of each data file of the corpus of data files. The metadata for a data file that was generated at a particular location (e.g., a capture location) can include any combination of: a label for each identified entity (e.g., an entity can be a person or an animal), an altitude at the capture location, a latitude of the capture location, a longitude of the capture location, a name of the capture location, a timestamp, a speed of the mobile device, a direction of travel of the mobile device, and an orientation of the image. The signals can comprise any combination of any number of signals in the following signal categories: persons, pets, cities, states, scenes, meanings, seasons, public events (e.g., concerts, festivals, fairs, meetups, sports events, theater performances, etc.), holidays, trips, business names, home locations, and. work locations. Signals can be identified by comparing the metadata for a data file against a database mapping metadata information to signals. For example, a signal for the holiday “Arbor Day” can be mapped to metadata information that would indicate that a data file was generated in the United States on the last Friday in April.

At block 430, a knowledge graph data structure representing associations between the corpus of data files from block 410 and the plurality of signals from block 420 can be generated. The knowledge graph data structure can comprise nodes connected by edges. Some nodes (e.g., cluster nodes) can represent data files that were generated within at least a particular time period or a particular distance of each other. These cluster nodes can be generated by clustering data files based on the concepts from block 420. In some embodiments, the knowledge graph data structure can include nodes representing signals (e.g., signal nodes), and the edges connecting a cluster node to a signal node can represent an association between the concept represented by the signal node and the cluster node. For example, a cluster node representing image files from a 4th of July trip to Miami Florida with a friend Osman and a pet dog Sally may be connected to signal nodes representing Miami Florida, Florida, the United States, Osman, Sally, Summer, the 4th of July, and July.

At block 440, the knowledge graph data structure from block 430 can be traversed to generate a respective score fore each signal of the plurality of signals from block 420. During the traversal, an algorithm can be used to navigate between nodes in the knowledge graph data structure using the edges. The algorithm can record the number of times that each signal node is encountered, and the number of encounters can be used to generate a score for each corresponding signal. A signal node that is encountered more frequently may be assumed to be more important than a signal node that is encountered less frequently.

At block 450, a plurality of search objects can be generated. The search objects can correspond to a signal of the plurality of signals. In some embodiments, each signal can be associated with a respective search object.

At block 460, the plurality of respective search objects for each signal of the plurality of signals can be ranked to generate a plurality of ranked search objects. The search objects can be ranked based at least in part on the scores for each search object from block 440. In some embodiments, the ranking may only include recent search objects that were generated during a particular time period (e.g., between a start date and time and an end date and time). In some embodiments, the ranking may remove search objects that were presented on a graphical user interface within a particular time period. In some embodiments, the ranking may remove search objects for which a corresponding graphical element on a graphical user interface was selected within a particular time period.

At block 470, a phrase can be generated from the plurality of ranked search objects. A phrase can be generated from the plurality of ranked search objects by identifying a template that corresponds to a particular search object. The system language of a data application (e.g., photo application) or a device executing the photo application (e.g., a mobile device; device 700) can be identified. The template and the particular search object can be provided to a trained machine learning model that is trained to generate language in the identified system language. In response, a phrase can be output by the trained machine learning model.

At block 480, the phrase from block 470 can be presented as a graphical element of a graphical user interface of the data application on a display of the mobile device according to the ranking. The mobile device can be device 700, and multiple graphical elements representing multiple phrases for multiple search objects can be presented on the graphical user interface simultaneously. An input identifying the graphical element can be received. The graphical element can be presented on a first region of the graphical user interface. The corpus of data files from block 410 can be searched to identify or more matching data files (e.g., in cluster nodes connected to the signal node corresponding to the search object used to generate the phrase). The one or more matching data files can be presented on a second region of the graphical user interface. Additional phrases can be presented as one or more additional graphical elements on one or more third regions of the graphical user interface.

Method 400 may include additional implementations, such as any single implementation or any combination of implementations described below and/or in connection with one or more other processes described elsewhere herein.

Although FIG. 4 shows example blocks of method 400, in some implementations, method 400 may include additional blocks, fewer blocks, different blocks, or differently arranged blocks than those depicted in FIG. 4. Additionally, or alternatively, two or more of the blocks of method 400 may be performed in parallel.

FIG. 5 depicts an architecture for training a machine learning model according to the embodiments of the present disclosure. Training vectors 505 are shown with a template and search object 510 and a known phrase 515. The search objects can be created from any type of data files in various embodiments. For example, the data files can be any combination of audio files, image files, video files, word processing files, and spreadsheet files. For case of illustration, only two training vectors are shown, but the number of training vectors may be much larger, e.g., 10, 10, 100, 1,000, 10,000, 100,000, or more. Training vectors could be made for different physical environments, the same physical environment over different time periods.

Templates and Search Objects 510 have property fields that can correspond to the output of the graph module and phrase module and the skilled person will appreciate the various ways that such sensor values can be configured. Known phrases 515 include phrases in a particular language that have been identified to correspond to the template and search object 510. In some embodiments there can be multiple machine learning models for multiple languages. The vector may identify a desired language for the phrase.

Training vectors 505 can be used by a learning service 525 to perform training 520. A service, such as learning service 525, being one or more computing devices configured to execute computer code to perform one or more operations that make up the service. Learning service 525 can optimize parameters of a model 535 such that a quality metric (e.g., accuracy of model 535) is achieved with one or more specified criteria. The accuracy may be measured by comparing known phrase 515 to predicted phrase 555. Parameters of model 535 can be iteratively varied to increase accuracy. Determining a quality metric can be implemented for any arbitrary function including the set of all risk, loss, utility, and decision functions.

In some embodiments of training, a gradient may be determined for how varying the parameters affects a cost function, which can provide a measure of how accurate the current state of the machine learning model is. The gradient can be used in conjunction with a learning step (e.g., a measure of how much the parameters of the model should be updated for a given time step of the optimization process). The parameters (which can include weights, matrix transformations, and probability distributions) can thus be optimized to provide an optimal value of the cost function, which can be measured as being above or below a threshold (i.e., exceeds a threshold) or that the cost function does not change significantly for several time steps, as examples. In other embodiments, training can be implemented with methods that do not require a hessian or gradient calculation, such as dynamic programming or evolutionary algorithms.

A prediction stage 530 can provide a predicted phrase 555 for a new entity's entity signature vector 540 based on a new template and search object 545. The predicted phrase 555 can be phrase that corresponds to the input vector 540. The new template and search object 555 can be of a similar type as template and search object 510. If new templates and search objects are of a different type, a transformation can be performed on the data to obtain data in a similar format as templates and search objects 510. Ideally, predicted phrase 555 corresponds to the desired phrase for input vector 540.

A “machine learning model” (ML model) can refer to a software module configured to be run on one or more processors to provide a classification or numerical value of a property of one or more samples. An ML model can be generated using sample data (e.g., training data) to make predictions on test data. One example is an unsupervised learning model. Another example type of model is supervised learning that can be used with embodiments of the present disclosure. Example supervised learning models may include different approaches and algorithms including analytical learning, statistical models, artificial neural network, backpropagation, boosting (meta-algorithm), Bayesian statistics, case-based reasoning, decision tree learning, inductive logic programming, Gaussian process regression, genetic programming, group method of data handling, kernel estimators, learning automata, learning classifier systems, minimum message length (decision trees, decision graphs, etc.), multilinear subspace learning, naive Bayes classifier, maximum entropy classifier, conditional random field, nearest neighbor algorithm, probably approximately correct learning (PAC) learning, ripple down rules, a knowledge acquisition methodology, symbolic machine learning algorithms, subsymbolic machine learning algorithms, minimum complexity machines (MCM), random forests, ensembles of classifiers, ordinal classification, data pre-processing, handling imbalanced datasets, statistical relational learning, or Proaftn, a multicriteria classification algorithm. The model may include linear regression, logistic regression, deep recurrent neural network (e.g., long short term memory, LSTM), hidden Markov model (HMM), linear discriminant analysis (LDA), k-means clustering, density-based spatial clustering of applications with noise (DBSCAN), random forest algorithm, support vector machine (SVM), or any model described herein. Supervised learning models can be trained in various ways using various cost/loss functions that define the error from the known label (e.g., least squares and absolute difference from known classification) and various optimization techniques, e.g., using backpropagation, steepest descent, conjugate gradient, and Newton and quasi-Newton techniques.

Examples of machine learning models include deep learning models, neural networks (e.g., deep learning neural networks), kernel-based regressions, adaptive basis regression or classification, Bayesian methods, ensemble methods, logistic regression and extensions, Gaussian processes, support vector machines (SVMs), a probabilistic model, and a probabilistic graphical model. Embodiments using neural networks can employ using wide and tensorized deep architectures, convolutional layers, dropout, various neural activations, and regularization steps.

FIG. 6 shows an example machine learning model of a neural network. A neural network is an example of a graph data structure. As an example, model 635 can be a neural network that comprises a number of neurons (e.g., Adaptive basis functions) organized in layers. For example, neuron 605 can be part of layer 610. The neurons can be connected by edges between neurons. For example, neuron 605 can be connected to neuron 615 by edge 620. A neuron can be connected to any number of different neurons in any number of layers. For instance, neuron 605 can be connected to neuron 625 by edge 630 in addition to being connected to neuron 615.

The training of the neural network can iteratively search for the best configuration of the parameter of the neural network for feature recognition and prediction performance. Various numbers of layers and nodes may be used. A person with skills in the art can easily recognize variations in a neural network design and design of other machine learning models. For example, neural networks can include graph neural networks that are configured to operate on unstructured data. A graph neural network can receive a graph (e.g., nodes connected by edges) as an input to the model and the graph neural network can learn the features of this input through pairwise message passing. In pairwise message passing, nodes exchange information and each node iteratively updates its representation based on the passed information. More detail about graph neural networks can be found in the following reference: Wu, Zonghan, et al. “A comprehensive survey on graph neural networks.” IEEE transactions on neural networks and learning systems 32.1 (2020): 8-2 8.

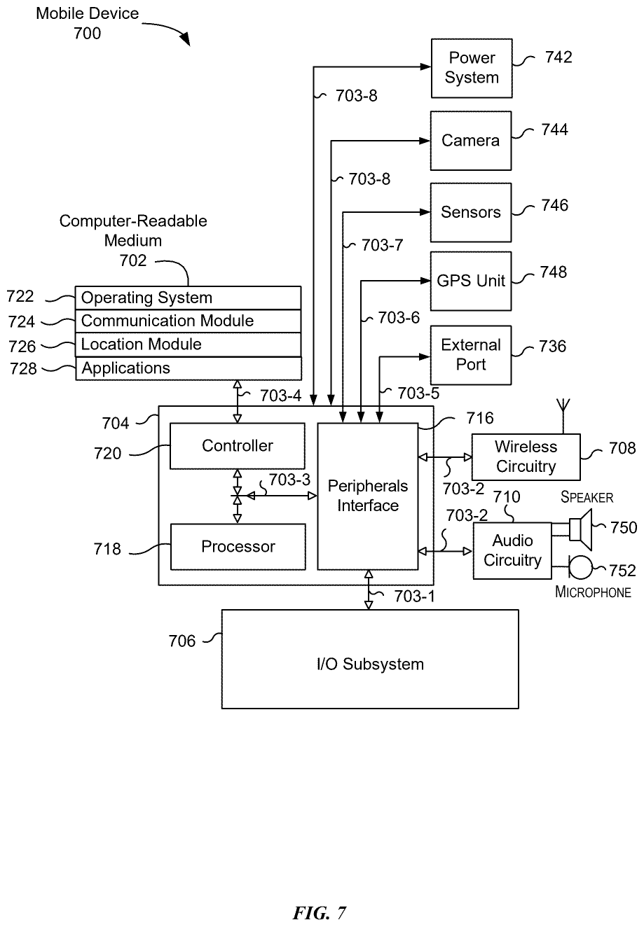

FIG. 7 is a block diagram of an example electronic device 700 according to various embodiments. Device 700 generally includes computer-readable medium 702, a processing system 704, an Input/Output (I/O) subsystem 706, wireless circuitry 708, and audio circuitry 710 including speaker 712 and microphone 714. These components may be coupled by one or more communication buses or signal lines 703. Device 700 can be any portable electronic device, including a handheld computer, a tablet computer, a mobile phone, laptop computer, tablet device, media player, personal digital assistant (PDA), a key fob, a car key, an access card, a multifunction device, a mobile phone, a portable gaming device, a headset, or the like, including a combination of two or more of these items.

it should be apparent that the architecture shown in FIG. 7 is only one example of an architecture for device 700, and that device 700 can have more or fewer components than shown, or a different configuration of components. The various components shown in FIG. 7 can be implemented in hardware, software, or a combination of both hardware and software, including one or more signal processing and/or application specific integrated circuits.

Wireless circuitry 708 is used to send and receive information over a wireless link or network to one or more other devices' conventional circuitry such as an antenna system, a radio frequency (RF) transceiver, one or more amplifiers, a tuner, one or more oscillators, a digital signal processor, a coder-decoder (CODEC) chipset, memory, etc. Wireless circuitry 708 can use various protocols, e.g., as described herein. In various embodiments, wireless circuitry 708 is capable of establishing and maintaining communications with other devices using one or more communication protocols, including time division multiple access (TDMA), code division multiple access (CDMA), global system for mobile communications (GSM), Enhanced Data GSM Environment (EDGE), wideband code division multiple access (W-CDMA), Long Term Evolution (LTE), LTE-Advanced, Wi-Fi (such as Institute of Electrical and Electronics Engineers (IEEE) 902.11a, IEEE 902.11b, IEEE 902.11g and/or IEEE 902.11n), Bluetooth, Wi-MAX, Voice Over Internet Protocol (VOIP), near field communication protocol (NFC), a protocol for email, instant messaging, and/or a short message service (SMS), or any other suitable communication protocol, including communication protocols not yet developed as of the filing date of this document.

Wireless circuitry 708 is coupled to processing system 704 via peripherals interface 716. Peripherals interface 716 can include conventional components for establishing and maintaining communication between peripherals and processing system 704. Voice and data information received by wireless circuitry 708 (e.g., in speech recognition or voice command applications) is sent to one or more processors 718 via peripherals interface 716. One or more processors 718 are configurable to process various data formats for one or more application programs 734 stored on medium 702.

Peripherals interface 716 couple the input and output peripherals of device 700 to the one or more processors 718 and computer-readable medium 702. One or more processors 718 communicate with computer-readable medium 702 via a controller 720. Computer-readable medium 702 can be any device or medium that can store code and/or data for use by one or more processors 718. Computer-readable medium 702 can include a memory hierarchy, including cache, main memory and secondary memory. The memory hierarchy can be implemented using any combination of random access memory (RAM) (e.g., static random access memory (SRAM,) dynamic random access memory (DRAM), double data random access memory (DDRAM)), read only memory (ROM), FLASH, magnetic and/or optical storage devices, such as disk drives, magnetic tape, CDs (compact disks) and DVDs (digital video discs). In some embodiments, peripherals interface 716, one or more processors 718, and controller 720 can be implemented on a single chip, such as processing system 704. In some other embodiments, they can be implemented on separate chips.

Processor(s) 718 can include hardware and/or software elements that perform one or more processing functions, such as mathematical operations, logical operations, data manipulation operations, data transfer operations, controlling the reception of user input, controlling output of information to users, or the like. Processor(s) 718 can be embodied as one or more hardware processors, microprocessors, microcontrollers, field programmable gate arrays (FPGAs), application-specified integrated circuits (ASICs), or the like.

Device 700 also includes a power system 742 for powering the various hardware components. Power system 742 can include a power management system, one or more power sources (e.g., battery, alternating current (AC)), a recharging system, a power failure detection circuit, a power converter or inverter, a power status indicator (e.g., a light emitting diode (LED)) and any other components typically associated with the generation, management and distribution of power in mobile devices.

In some embodiments, device 700 includes a camera 744. In some embodiments, device 700 includes sensors 746. Sensors can include accelerometers, compass, gyrometer, pressure sensors, audio sensors, light sensors, barometers, and the like. Sensors 746 can be used to sense location aspects, such as auditory or light signatures of a location.

In some embodiments, device 700 can include a GPS receiver, sometimes referred to as a GPS unit 748. A mobile device can use a satellite navigation system, such as the Global Positioning System (GPS), to obtain position information, timing information, altitude, or other navigation information. During operation, the GPS unit can receive signals from GPS satellites orbiting the Earth. The GPS unit analyzes the signals to make a transit time and distance estimation. The GPS unit can determine the current position (current location) of the mobile device. Based on these estimations, the mobile device can determine a location fix, altitude, and/or current speed. A location fix can be geographical coordinates such as latitudinal and longitudinal information.

One or more processors 718 run various software components stored in medium 702 to perform various functions for device 700. In some embodiments, the software components include an operating system 722, a communication module 724 (or set of instructions), a location module 726 (or set of instructions), and other application programs 728 (or set of instructions).

Operating system 722 can be any suitable operating system, including iOS, Mac OS, Darwin, Real Time Operating System (RTXC), LINUX, UNIX, OS X, WINDOWS, or an embedded operating system such as VxWorks. The operating system can include various procedures, sets of instructions, software components and/or drivers for controlling and managing general system tasks (e.g., memory management, storage device control, power management, etc.) and facilitates communication between various hardware and software components.

Communication module 724 facilitates communication with other devices over one or more external ports 736 or via wireless circuitry 708 and includes various software components for handling data received from wireless circuitry 708 and/or external port 736. External port 736 (e.g., universal serial bus (USB), Fire Wire, Lightning connector, 70-pin connector, etc.) is adapted for coupling directly to other devices or indirectly over a network (e.g., the Internet, wireless local area network (LAN), etc.).

Location module 726 can assist in determining the current position (e.g., coordinates or other geographic location identifiers) and motion of device 700. Modern positioning systems include satellite based positioning systems, such as Global Positioning System (GPS), cellular network positioning based on “cell IDs,” and Wi-Fi positioning technology based on a Wi-Fi networks. GPS also relies on the visibility of multiple satellites to determine a position estimate, which may not be visible (or have weak signals) indoors or in “urban canyons.” In some embodiments, location/motion module 726 receives data from GPS unit 748 and analyzes the signals to determine the current position of the mobile device. In some embodiments, location/motion module 726 can determine a current location using Wi-Fi or cellular location technology. For example, the location of the mobile device can be estimated using knowledge of nearby cell sites and/or Wi-Fi access points with knowledge also of their locations. Information identifying the Wi-Fi or cellular transmitter is received at wireless circuitry 708 and is passed to location/motion module 726. In some embodiments, the location module receives the one or more transmitter IDs. In some embodiments, a sequence of transmitter IDs can be compared with a reference database (e.g., Cell ID database, Wi-Fi reference database) that maps or correlates the transmitter IDs to position coordinates of corresponding transmitters, and computes estimated position coordinates for device 700 based on the position coordinates of the corresponding transmitters. Regardless of the specific location technology used, location/motion module 726 receives information from which a location fix can be derived, interprets that information, and returns location information, such as geographic coordinates, latitude/longitude, or other location fix data.

The one or more applications 728 on device 700 can include any applications installed on the device 700, including without limitation, a photo application (e.g., data application 100) a browser, address book, contact list, email, instant messaging, social networking, word processing, keyboard emulation, widgets, JAVA-enabled applications, encryption, digital rights management, voice recognition, voice replication, a music player (which plays back recorded music stored in one or more files, such as MP3 or AAC files), etc.

There may be other modules or sets of instructions (not shown), such as a graphics module, a time module, etc. For example, the graphics module can include various conventional software components for rendering, animating and displaying graphical objects (including without limitation text, web pages, icons, digital images, animations and the like) on a display surface. In another example, a timer module can be a software timer. The timer module can also be implemented in hardware. The time module can maintain various timers for any number of events.

I/O subsystem 706 can be coupled to a display system (not shown), which can be a touch-sensitive display. The display displays visual output to the user in a GUI. The visual output can include text, graphics, video, and any combination thereof. Some or all of the visual output can correspond to user-interface objects. A display can use LED (light emitting diode), LCD (liquid crystal display) technology, or LPD (light emitting polymer display) technology, although other display technologies can be used in other embodiments.

In some embodiments, I/O subsystem 706 can include a display and user input devices such as a keyboard, mouse, and/or trackpad. In some embodiments, I/O subsystem 706 can include a touch-sensitive display. A touch-sensitive display can also accept input from the user based at least part on haptic and/or tactile contact. In some embodiments, a touch-sensitive display forms a touch-sensitive surface that accepts user input. The touch-sensitive display/surface (along with any associated modules and/or sets of instructions in computer-readable medium 702) detects contact (and any movement or release of the contact) on the touch-sensitive display and converts the detected contact into interaction with user-interface objects, such as one or more soft keys, that are displayed on the touch screen when the contact occurs. In some embodiments, a point of contact between the touch-sensitive display and the user corresponds to one or more digits of the user. The user can make contact with the touch-sensitive display using any suitable object or appendage, such as a stylus, pen, finger, and so forth. A touch-sensitive display surface can detect contact and any movement or release thereof using any suitable touch sensitivity technologies, including capacitive, resistive, infrared, and surface acoustic wave technologies, as well as other proximity sensor arrays or other elements for determining one or more points of contact with the touch-sensitive display.

Further, I/O subsystem 706 can be coupled to one or more other physical control devices (not shown), such as pushbuttons, keys, switches, rocker buttons, dials, slider switches, sticks, LEDs, etc., for controlling or performing various functions, such as power control, speaker volume control, ring tone loudness, keyboard input, scrolling, hold, menu, screen lock, clearing and ending communications and the like. In some embodiments, in addition to the touch screen, device 700 can include a touchpad (not shown) for activating or deactivating particular functions. In some embodiments, the touchpad is a touch-sensitive area of the device that, unlike the touch screen, does not display visual output. The touchpad can be a touch-sensitive surface that is separate from the touch-sensitive display or an extension of the touch-sensitive surface formed by the touch-sensitive display.

In some embodiments, some or all of the operations described herein can be performed using an application executing on the user's device. Circuits, logic modules, processors, and/or other components may be configured to perform various operations described herein. Those skilled in the art will appreciate that, depending on implementation, such configuration can be accomplished through design, setup, interconnection, and/or programming of the particular components and that, again depending on implementation, a configured component might or might not be reconfigurable for a different operation. For example, a programmable processor can be configured by providing suitable executable code; a dedicated logic circuit can be configured by suitably connecting logic gates and other circuit elements; and so on.

Any of the software components or functions described in this application may be implemented as software code to be executed by a processor using any suitable computer language such as, for example, Java, C, C++, C#, Objective-C, Swift, or scripting language such as Perl or Python using, for example, conventional or object-oriented techniques. The software code may be stored as a series of instructions or commands on a computer readable medium for storage and/or transmission. A suitable non-transitory computer readable medium can include random access memory (RAM), a read only memory (ROM), a magnetic medium such as a hard-drive or a floppy disk, or an optical medium, such as a compact disk (CD) or DVD (digital versatile disk), flash memory, and the like. The computer readable medium may be any combination of such storage or transmission devices.

Computer programs incorporating various features of the present disclosure may be encoded on various computer readable storage media; suitable media include magnetic disk or tape, optical storage media, such as compact disk (CD) or DVD (digital versatile disk), flash memory, and the like. Computer readable storage media encoded with the program code may be packaged with a compatible device or provided separately from other devices. In addition, program code may be encoded and transmitted via wired optical, and/or wireless networks conforming to a variety of protocols, including the Internet, thereby allowing distribution, e.g., via Internet download. Any such computer readable medium may reside on or within a single computer product (e.g. a solid state drive, a hard drive, a CD, or an entire computer system), and may be present on or within different computer products within a system or network. A computer system may include a monitor, printer, or other suitable display for providing any of the results mentioned herein to a user.

As described above, one aspect of the present technology is the gathering, sharing, and use of data, including an authentication tag and data from which the tag is derived. The present disclosure contemplates that in some instances, this gathered data may include personal information data that uniquely identifies or can be used to contact or locate a specific person. Such personal information data can include demographic data, location-based data, telephone numbers, email addresses, twitter ID's, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to authenticate another device, and vice versa to control which devices ranging operations may be performed. Further, other uses for personal information data that benefit the user are also contemplated by the present disclosure. For instance, health and fitness data may be shared to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of sharing content and performing ranging, the present technology can be configured to allow users to select to “opt in” or “opt out” of participation in the collection of personal information data during registration for services or anytime thereafter. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data.

Although the present disclosure has been described with respect to specific embodiments, it will be appreciated that the disclosure is intended to cover all modifications and equivalents within the scope of the following claims.

All patents, patent applications, publications, and descriptions mentioned herein are incorporated by reference in their entirety for all purposes. None is admitted to be prior art.

The specification and drawings are, accordingly, to be regarded in an illustrative rather than a restrictive sense. It will, however, be evident that various modifications and changes may be made thereunto without departing from the broader spirit and scope of the disclosure as set forth in the claims.

Other variations are within the spirit of the present disclosure. Thus, while the disclosed techniques are susceptible to various modifications and alternative constructions, certain illustrated embodiments thereof are shown in the drawings and have been described above in detail. It should be understood, however, that there is no intention to limit the disclosure to the specific form or forms disclosed, but on the contrary, the intention is to cover all modifications, alternative constructions and equivalents falling within the spirit and scope of the disclosure, as defined in the appended claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. The phrase “based on” should be understood to be open-ended, and not limiting in any way, and is intended to be interpreted or otherwise read as “based at least in part on,” where appropriate. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the disclosure and does not pose a limitation on the scope of the disclosure unless otherwise claimed. No language in the specification should be construed as indicating any non-claimed element as essential to the practice of the disclosure. The use of “or” is intended to mean an “inclusive or,” and not an “exclusive or” unless specifically indicated to the contrary. Reference to a “first” component does not necessarily require that a second component be provided. Moreover reference to a “first” or a “second” component does not limit the referenced component to a particular location unless expressly stated. The term “based on” is intended to mean “based at least in part on.”

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present. Additionally, conjunctive language such as the phrase “at least one of X, Y, and Z,” unless specifically stated otherwise, should also be understood to mean X, Y, Z, or any combination thereof, including “X, Y, and/or Z.”

Preferred embodiments of this disclosure are described herein, including the best mode known to the inventors for carrying out the disclosure. Variations of those preferred embodiments may become apparent to those of ordinary skill in the art upon reading the foregoing description. The inventors expect skilled artisans to employ such variations as appropriate, and the inventors intend for the disclosure to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

All references, including publications, patent applications, and patents, cited herein are hereby incorporated by reference to the same extent as if each reference were individually and specifically indicated to be incorporated by reference and were set forth in its entirety herein.

Implementations within the scope of the present disclosure can be partially or entirely realized using a tangible computer-readable storage medium (or multiple tangible computer-readable storage media of one or more types) encoding one or more computer-readable instructions. It should be recognized that computer-executable instructions can be organized in any format, including applications, widgets, processes, software, and/or components.

Implementations within the scope of the present disclosure include a computer-readable storage medium that encodes instructions organized as an application that, when executed by one or more processing units, control an electronic device to perform any of the methods described herein.

It should be recognized that the application can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application. In some embodiments, the application is an application that is pre-installed on device at purchase (e.g., a first party application). In other embodiments, the application is an application that is provided to the device via an operating system update file (e.g., a first party application or a second party application). In other embodiments, the application is an application that is provided via an application store. In some embodiments, the application store can be an application store that is pre-installed on the device at purchase (e.g., a first party application store). In other embodiments, the application store is a third-party application store (e.g., an application store that is provided by another application store, downloaded via a network, and/or read from a storage device).

What is claimed is:

1. A method comprising:
accessing, by a photo application of a mobile device, a corpus of image files, wherein each image file of the corpus of image files comprises respective metadata;
identifying, by the photo application of the mobile device, a plurality of signals based at least in part on an analysis of the respective metadata of each image file of the corpus of image files;
generating, by the photo application of the mobile device, a knowledge graph data structure representing associations between the corpus of image files and the plurality of signals;
traversing, by the photo application of the mobile device, the knowledge graph data structure to generate a respective score for each signal of the plurality of signals;
generating, by the photo application of the mobile device, a plurality of search objects comprising a respective search object for each signal of the plurality of signals;
ranking, by the photo application of the mobile device, the plurality of respective search objects for each signal of the plurality of signals to generate a plurality of ranked search objects, the ranking based at least in part on the score for each signal of the plurality of signals;
generating, by the photo application of the mobile device, a phrase from the plurality of signals and the plurality of ranked search objects; and
presenting, by the photo application of the mobile device, the phrase as a graphical element of a graphical user interface of the photo application on a display of the mobile device according to the ranking.

2. The method of claim 1, wherein each signal of the plurality of signals corresponds to one or more of a plurality of signal categories comprising at least one of:
persons;
pets;
cities;
states;
scenes;
meanings;
seasons;
public events;
holidays;
trips;
business names;
home locations; or
work locations.

3. The method of claim 2, wherein multiple signals correspond to a particular category of the plurality of signal categories.

4. The method of claim 1, further comprising:
receiving, by the photo application of the mobile device, an input identifying the graphical element, where the graphical element is displayed on a first region of the graphical user interface;
searching, by the photo application of the mobile device, the corpus of image files to identify one or more matching image files; and
presenting, by the photo application of the mobile device, the one or more matching image files on a second region of the graphical user interface.

5. The method of claim 1, wherein analyzing the metadata comprises:
comparing, by the photo application of the mobile device, pairs of metadata files to identify context information that is present in a first metadata of the pair of metadata files and absent from a second metadata file of the pair of metadata files; and
associating, by the photo application of the mobile device, the context information with the second metadata.

6. The method of claim 5, further comprising:
identifying, by the photo application of the mobile device, two or more image files with corresponding metadata that contain information identifying a common capture location and a common timestamp; and
associating, by the photo application of mobile device, the two or more image files with an event at the common capture location and the common timestamp.

7. The method of claim 6, wherein the metadata of two image files contain information identifying the common capture location if:
a first capture location of a first image of the two image files is within a threshold distance of a second capture location of a second image file of the two image files.

8. The method of claim 6, wherein the metadata of two image files contain information identifying the common timestamp:
a first timestamp of a first image file of the two image files is within a threshold time period of a second timestamp of a second image file of the two image files.

9. The method of claim 5, wherein the metadata of an image file captured by the photo application at a capture location comprises the context information identifying at least one of:
a label for each identified entity, where an entity is a person or an animal;
an altitude at the capture location;
a latitude of the capture location;
a longitude of the capture location;
a name of the capture location;
a timestamp;
a speed of the mobile device;
a direction of travel of the mobile device; or
an orientation of the image file.

10. The method of claim 1, wherein analyzing metadata of the corpus of image files comprises:
filtering, by the photo application of mobile device, the corpus of image files to identify a set of recent image files; and
identifying, by the photo application of mobile device, the plurality of signals in metadata of the set of recent image files.

11. The method of claim 1, wherein generating the phrase comprises:
identifying, by the photo application of mobile device, a template that corresponds to a particular search object;
identifying, by the photo application of mobile device, a system language of the mobile device or the photo application;
providing, by the photo application of mobile device, the template and the particular search object to a machine learning model that is trained to generate language in the system language; and
receiving, by the photo application of mobile device, the phrase as output from the machine learning model.

12. A computing device, comprising:
one or more memories; and
one or more processors in communication with the one or more memories and configured to execute instructions stored in the one or more memories to performing operations to:
access, by a photo application of the computing device, a corpus of image files, wherein each image file of the corpus of image files comprises respective metadata;
identify, by the photo application of the computing device, a plurality of signals based at least in part on an analysis of the respective metadata of each image file of the corpus of image files;
generate, by the photo application of the computing device, a knowledge graph data structure representing associations between the corpus of image files and the plurality of signals;
traverse, by the photo application of the computing device, the knowledge graph data structure to generate a respective score for each signal of the plurality of signals;
generate, by the photo application of the computing device, a plurality of search objects comprising a respective search object for each signal of the plurality of signals;
rank, by the photo application of the computing device, the plurality of respective search objects for each signal of the plurality of signals to generate a plurality of ranked search objects, the ranking based at least in part on the score for each signal of the plurality of signals;
generate, by the photo application of the computing device, a phrase from the plurality of signals and the plurality of ranked search objects; and
present, by the photo application of the computing device, the phrase as a graphical element of a graphical user interface of the photo application on a display of the computing device according to the ranking.

13. The computing device of claim 12, wherein each signal of the plurality of signals corresponds to one or more of a plurality of signal categories comprising at least one of:
persons;
pets;
cities;
states;
scenes;
meanings;
seasons;
public events;
holidays;
trips;
business names;
home locations; or
work locations.

14. The computing device of claim 13, wherein multiple signals correspond to a particular category of the plurality of signal categories.

15. The computing device of claim 12, further comprising operations to:
receive, by the photo application of the computing device, an input identifying the graphical element, where the graphical element is displayed on a first region of the graphical user interface;
search, by the photo application of the computing device, the corpus of image files to identify one or more matching image files; and
present, by the photo application of the computing device, the one or more matching image files on a second region of the graphical user interface.

16. The computing device of claim 12, wherein analyzing the metadata comprises operations to:
compare, by the photo application of the computing device, pairs of metadata files to identify context information that is present in a first metadata of the pair of metadata files and absent from a second metadata file of the pair of metadata files; and
associate, by the photo application of the computing device, the identified information with the second metadata.

17. A non-transitory computer-readable medium storing a plurality of instructions that, when executed by one or more processors of a computing device, cause the one or more processors to perform operations to:
access, by a photo application of the computing device, a corpus of image files, wherein each image file of the corpus of image files comprises respective metadata;
identify, by the photo application of the computing device, a plurality of signals based at least in part on an analysis of the respective metadata of each image file of the corpus of image files;
generate, by the photo application of the computing device, a knowledge graph data structure representing associations between the corpus of image files and the plurality of signals;
traverse, by the photo application of the computing device, the knowledge graph data structure to generate a respective score for each signal of the plurality of signals;
generate, by the photo application of the computing device, a plurality of search objects comprising a respective search object for each signal of the plurality of signals;
rank, by the photo application of the computing device, the plurality of respective search objects for each signal of the plurality of signals to generate a plurality of ranked search objects, the ranking based at least in part on the score for each signal of the plurality of signals;
generate, by the photo application of the computing device, a phrase from the plurality of signals and the plurality of ranked search objects; and
present, by the photo application of the computing device, the phrase as a graphical element of a graphical user interface of the photo application on a display of the computing device according to the ranking.

18. The non-transitory computer-readable medium of claim 17, wherein each signal of the plurality of signals corresponds to one or more of a plurality of signal categories comprising at least one of:
persons;
pets;
cities;
states;
scenes;
meanings;
seasons;
public events;
holidays;
trips;
business names;
home locations; or
work locations.

19. The non-transitory computer-readable medium of claim 18, wherein multiple signals correspond to a particular category of the plurality of signal categories.

20. The non-transitory computer-readable medium of claim 17, further comprising operations to:
receive, by the photo application of the computing device, an input identifying the graphical element, where the graphical element is displayed on a first region of the graphical user interface;
search, by the photo application of the computing device, the corpus of image files to identify one or more matching image files; and
present, by the photo application of the computing device, the one or more matching image files on a second region of the graphical user interface.
